(19) United States
(12) Patent Application Publication
(10) Pub. No.: US 2025/0003471 A1
(43) Pub. Date: Jan. 2, 2025

(54) Actuator Device, Clutch Device, and Air Outlet Device

(71) Applicant: Illinois Tool Works Inc., Glenview, IL (US)

(72) Inventor: Dongdong WANG, Shanghai (CN)

(21) Appl. No.: 18/751,699

(22) Filed: Jun. 24, 2024

(30) Foreign Application Priority Data
Jun. 28, 2023 (CN) 202310779443.4
Jun. 13, 2024 (CN) 202410763563.X

(51) Int. Cl. F16H 31/00; B60H 1/34; F16D 41/066; F16D 41/069

(52) U.S. Cl. CPC F16H 31/001; B60H 1/3421; F16D 41/066; F16D 41/069; B60H 2001/3471

(57) ABSTRACT

The present disclosure relates to an actuator device, comprising a driving component, a gear, a first rotary transmission device, and a second rotary transmission device. The driving component comprises a drive rotating shaft, and the first rotary transmission device comprises a first connecting and disconnecting device and has a first output shaft. The second rotary transmission device comprises a second connecting and disconnecting device, and the second rotary transmission device has a second output shaft. When the gear rotates in a first rotation direction or a second rotation direction, one of the first rotary transmission device and the second rotary transmission device is driven, so that one of the connecting and disconnecting devices is driven into an engaged state, wherein one of the output shafts rotates while the other output shaft does not rotate. The actuator device according to the present disclosure has a stable connecting and disconnecting process and a stable output, and can implement double outputs by means of a single actuator. The two output shafts are symmetrically arranged with respect to a rotating shaft of the driving gear and are spaced apart by a certain distance, so that outputs of the output shafts are relatively balanced and do not interfere with each other.

### RELATED APPLICATIONS

The present application claims the benefit of Chinese Patent Application Nos. CN 202310779443.4, filed Jun. 28, 2023, and 202410763563.X, filed Jun. 13, 2024, each titled “Actuator Device, Clutch Device, and Air Outlet Device,” the contents of which are hereby incorporated by reference.

### TECHNICAL FIELD

The present disclosure relates to an actuator device, a clutch device, and an air outlet device, and in particular, to an actuator with a clutch, a clutch device, and an air outlet device with the actuator and the clutch.

### BACKGROUND

In an air outlet device of a ventilation system or an air conditioning system, usually different blade groups that sweep air up and down or left and right are provided, and a separate motor is required to control the swing of each group of blades.

### SUMMARY

The present disclosure relates generally to a rotary transmission device and/or an actuator device, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A is a perspective view of an actuator device according to the present disclosure.

FIG. 1B is a perspective view of an actuator device according to the present disclosure with an actuator upper cover hidden.

FIG. 1C is a perspective view of the actuator device shown in FIG. 1B with a driving gear disengaged.

FIG. 1D is a perspective view of a driving gear in an actuator device according to the present disclosure.

FIG. 1E is a perspective view of a rotary transmission device in an actuator device according to the present disclosure.

FIG. 2A is a perspective view of a clutch device according to the present disclosure.

FIG. 2B is a perspective view of a clutch device according to the present disclosure with a clutch upper cover hidden.

FIG. 3A is a perspective view of an example of an air outlet device with the clutch device shown in FIGS. 2A-2B.

FIG. 3B is an exploded view of the air outlet device shown in FIG. 3A.

FIG. 3C is a perspective view of the air outlet device shown in FIG. 3A with a driving device hidden.

FIG. 3D is a schematic driving diagram of the air outlet device shown in FIG. 3A from a first perspective.

FIG. 3E is a schematic driving diagram of the air outlet device shown in FIG. 3A from a second perspective.

FIG. 3F is a perspective view of the air outlet device shown in FIG. 3B from another perspective.

FIG. 3G is a perspective view of the air outlet device shown in FIG. 3B from a side perspective.

FIG. 4A is a perspective view of a bevel gear in an air outlet device.

FIG. 4B is a front view of a bevel gear in an air outlet device.

FIG. 5A is a perspective view of another example of an air outlet device with the clutch device shown in FIGS. 2A-2B.

FIG. 5B is an exploded view of the air outlet device shown in FIG. 5A.

FIG. 5C is a schematic driving diagram of the air outlet device shown in FIG. 5A from a first perspective.

FIG. 5D is a schematic driving diagram of the air outlet device shown in FIG. 5A from a second perspective.

FIG. 6 is a perspective view of an air outlet device system with the clutch device shown in FIGS. 2A-2B.

FIG. 7A is an enlarged view M of a blade control system in FIG. 3F.

FIG. 7B is an enlarged view N of a blade control system in FIG. 3G.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein.

Various specific implementations of the present disclosure will be described below with reference to the accompanying drawings which constitute part of the present disclosure, but does not limit the present disclosure. It should be understood that although the terms indicating directions, such as “upper”, “lower”, “left”, “right”, “front” and “rear” are used in the present disclosure to describe orientations of structural parts and elements in various examples of the present disclosure, these terms are used herein only for case of illustration and are determined based on the exemplary orientations shown in the accompanying drawings. Since the examples of the present disclosure can be arranged in different directions, these terms indicating directions are merely illustrative and should not be considered as limitations.

The terms “first”, “second”, “third”, etc. used in the present disclosure are merely used to distinguish different objects, instead of indicating that there is any particular sequential relationship between these objects. The term “comprise/include” and derivatives thereof mean inclusion without limitation. Unless otherwise specified and limited, the terms “mounting”, “connecting” and “connection” should be understood broadly. For example, they may be a mechanical or electrical connection, internal communication between two elements, or a direct connection or indirect connection via an intermediate medium. For those of ordinary skills in the art, the specific meanings of the above terms can be understood according to specific cases. If possible, the same or similar reference signs used in the present disclosure refer to the same components.

According to a first aspect of the present disclosure, an actuator device is provided, the actuator device comprising a driving component, a gear, a first rotary transmission device, and a second rotary transmission device, wherein the driving component comprises a drive rotating shaft, the driving component is configured to be capable of driving the drive rotating shaft to rotate in a first rotation direction or a second rotation direction, the gear comprises a gear rotating shaft, the gear is configured to be driven by the drive rotating shaft to rotate in the first rotation direction or the second rotation direction, the first rotary transmission device comprises a first connecting and disconnecting device, and the first rotary transmission device has a first output shaft; and the second rotary transmission device comprises a second connecting and disconnecting device, and the second rotary transmission device has a second output shaft, wherein the first connecting and disconnecting device and the second connecting and disconnecting device are configured such that when the gear rotates in the first rotation direction, the first rotary transmission device is driven to allow the first connecting and disconnecting device to be driven into an engaged state such that the first output shaft rotates, and the second rotary transmission device is driven to allow the second connecting and disconnecting device to be driven into a disengaged state such that the second output shaft does not rotate; or when the gear rotates in the second rotation direction, the second rotary transmission device is driven to allow the second connecting and disconnecting device to be driven into an engaged state such that the second output shaft rotates, and the first rotary transmission device is driven to allow the first connecting and disconnecting device to be driven into a disengaged state such that the first output shaft does not rotate.

According to the first aspect of the present disclosure, the first output shaft and the second output shaft are spaced apart from the gear rotating shaft by a certain distance.

According to the first aspect of the present disclosure, the first output shaft and the second output shaft are arranged on two sides of the gear rotating shaft.

According to the first aspect of the present disclosure, the first output shaft and the second output shaft are symmetrically arranged with respect to the gear rotating shaft.

According to the first aspect of the present disclosure, the first connecting and disconnecting device and the second connecting and disconnecting device are roller clutches or sprag clutches, wherein either the first connecting and disconnecting device or the second connecting and disconnecting device comprises at least one roller or at least one sprag.

According to the first aspect of the present disclosure, the actuator device further comprises: a transmission mechanism, the transmission mechanism being configured to be cooperatively connected to the driving component and the gear to transfer a torque of the drive rotating shaft of the driving component to the gear.

According to the first aspect of the present disclosure, the transmission mechanism is a decelerating mechanism for allowing the rotation speed of the gear to be lower than that of the drive rotating shaft.

According to the first aspect of the present disclosure, the rotation of the drive rotating shaft of the driving component in the first rotation direction or the second rotation direction is controlled by means of a controller.

According to the first aspect of the present disclosure, the first rotation direction is opposite to the second rotation direction.

According to the first aspect of the present disclosure, the first connecting and disconnecting device and the second connecting and disconnecting device are configured at a final output stage of the actuator device.

According to a second aspect of the present disclosure, a clutch device is provided, the clutch device comprising a gear, a first rotary transmission device, and a second rotary transmission device, wherein the gear comprises a gear rotating shaft, the gear rotating shaft is configured to be driven by a driving device to rotate in a first rotation direction or a second rotation direction, the first rotary transmission device comprises a first connecting and disconnecting device, the first rotary transmission device has a first output shaft, the second rotary transmission device comprises a second connecting and disconnecting device, and the second rotary transmission device has a second output shaft, wherein the first connecting and disconnecting device and the second connecting and disconnecting device are configured such that when the gear rotating shaft rotates in the first rotation direction, the first rotary transmission device is driven to allow the first connecting and disconnecting device to be driven into an engaged state such that the first output shaft rotates, and the second rotary transmission device is driven to allow the second connecting and disconnecting device to be driven into a disengaged state such that the second output shaft does not rotate; when the gear rotating shaft rotates in the second rotation direction, the second rotary transmission device is driven to allow the second connecting and disconnecting device to be driven into an engaged state such that the second output shaft rotates, and the first rotary transmission device is driven to allow the first connecting and disconnecting device to be driven into a disengaged state such that the first output shaft does not rotate.

According to the second aspect of the present disclosure, the first output shaft and the second output shaft are spaced apart from the gear rotating shaft by a certain distance.

According to the second aspect of the present disclosure, the first output shaft and the second output shaft are arranged on two sides of the gear rotating shaft.

According to the second aspect of the present disclosure, the first output shaft and the second output shaft are symmetrically arranged with respect to the gear rotating shaft.

According to the second aspect of the present disclosure, the first connecting and disconnecting device and the second connecting and disconnecting device are roller clutches or sprag clutches, and either the first connecting and disconnecting device or the second connecting and disconnecting device comprises at least one roller or at least one sprag.

According to the second aspect of the present disclosure, the first rotation direction is opposite to the second rotation direction.

According to a third aspect of the present disclosure, an air outlet device is provided, the air outlet device comprising an actuator device of the first aspect of the present disclosure or a clutch device of the second aspect of the present disclosure.

According to the third aspect of the present disclosure, the air outlet device further comprises: a first blade group and a second blade group, wherein the rotation of the driving component or the gear rotating shaft in the first rotation direction can drive the first blade group, and the rotation of the driving component or the gear rotating shaft in the second rotation direction can be used to drive the second blade group.

Some of the additional aspects and advantages of the present disclosure will be set forth in the following description, and some will become apparent from the following description, or be learned by practice of the present disclosure.

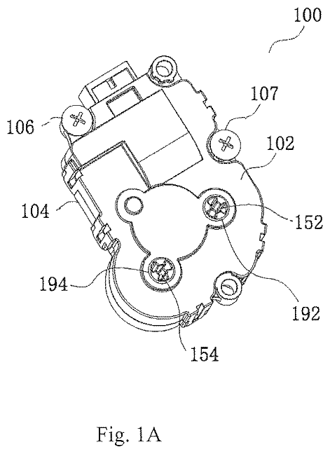

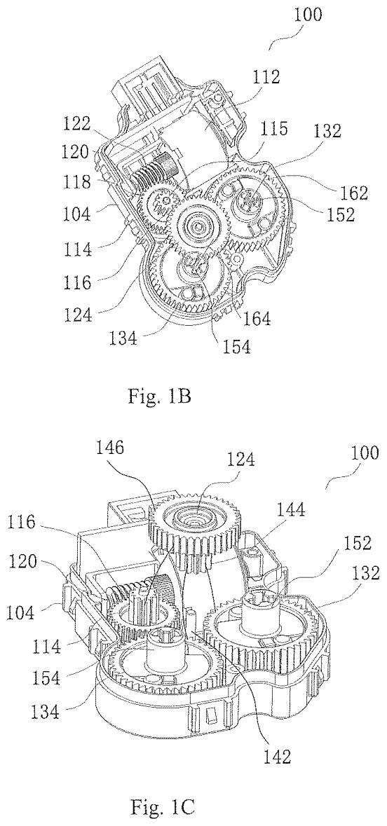

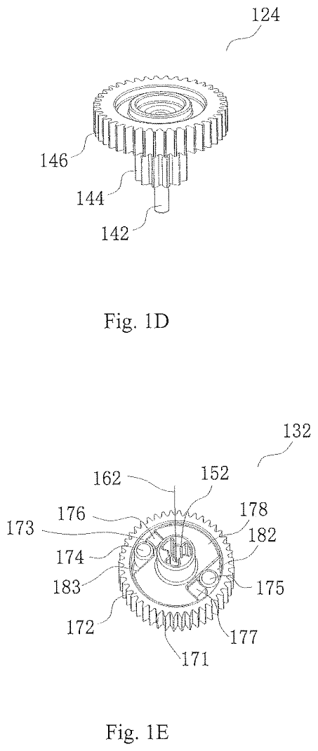

FIGS. 1A-1E show a specific structure of an actuator device 100 according to the present disclosure. FIG. 1A is a perspective view of the actuator device 100 according to the present disclosure. In FIG. 1B, an actuator upper cover 102 of the actuator device 100 is hidden to show more components inside the actuator device 100. FIG. 1C disengages a driving gear 124 of the actuator device 100 of FIG. 1B, so as to show a mating relationship of the driving gear 124 with a first rotary transmission device 132 and a second rotary transmission device 134. Figure ID is a perspective view of the driving gear 124 in the actuator device 100 according to the present disclosure. FIG. 1E is a perspective view of a rotary transmission device in the actuator device 100 according to the present disclosure.

As shown in FIG. 1A, the actuator device 100 comprises an actuator upper cover 102 and an actuator housing 104. The actuator upper cover 102 and the actuator housing 104 are fixed together by connectors 106, 107 (e.g., screws). The actuator device 100 has two output shafts 152, 154, and the two output shafts 152, 154 are parallel to each other and are spaced apart by a certain distance. The actuator upper cover 102 has two shaft holes 192, 194, with dimensions and positions just enough to expose ends of the two output shafts 152, 154, so as to facilitate connection between the two output shafts 152, 154 and a driven member.

For those of ordinary skill in the art, in some other examples, the two output shafts 152, 154 may alternatively be arranged non-parallel to each other. For example, rotation axes of the two output shafts 152, 154 are provided at an angle with each other.

As shown in FIGS. 1B and 1C, the actuator device 100 is internally provided with a driving component, such as a rotary driving motor 112, a transmission gear 114, a driving gear 124, a first rotary transmission device 132, and a second rotary transmission device 134.

The rotary driving motor 112 comprises a drive rotating shaft 120, which can rotate in a first rotation direction or a second rotation direction. The first rotation direction is opposite to the second rotation direction. The drive rotating shaft 120 meshes with the transmission gear 114 by means of a worm gear. The rotary driving motor 112 can be controlled by a control mechanism (not shown in the figure), so that the drive rotating shaft 120 rotates in the first rotation direction or the second rotation direction according to the needs of control.

The transmission gear 114 has a rotating shaft 115, and a first transmission gear tooth portion 118 and a second transmission gear tooth portion 116 that are coaxial and are spaced apart in an axial direction. A worm structure of the drive rotating shaft 120 can mesh with the first transmission gear tooth portion 118 of the transmission gear 114 by means of a worm gear and transmit a torque output by the rotary driving motor 112 to the transmission gear 114, so that the transmission gear 114 rotates around the rotating shaft 115. The rotation of the transmission gear 114 can further drive the driving gear 124 to rotate by means of tooth meshing between the second transmission gear tooth portion 116 and the driving gear 124.

Since both the outer diameter and the number of teeth of the first transmission gear tooth portion 118 of the transmission gear 114 are greater than those of the second transmission gear tooth portion 116, the transmission gear 114 can achieve a speed reduction effect (for example, reducing the rotation speed of the rotary driving motor 112) during transmission of a rotation torque, and can be used as a decelerating mechanism of the actuator device 100.

As shown in FIGS. 1C and 1D, the driving gear 124 comprises a driving gear rotating shaft 142, and a first driving gear tooth portion 146 and a second driving gear tooth portion 144 that are coaxial and are axially spaced apart. The first driving gear tooth portion 146 can keep meshing with the second transmission gear tooth portion 116, so that the driving gear 124 can be driven by the drive rotating shaft 120 to rotate clockwise or counterclockwise. The second driving gear tooth portion 144 can mesh with the first rotary transmission device 132 and the second rotary transmission device 134, so that the rotation of the driving gear 124 is transmitted to the first rotary transmission device 132 and the second rotary transmission device 134 at the same time.

In an example of the present disclosure, the transmission gear 114 and the driving gear 124 may alternatively be jointly used as a decelerating mechanism of the actuator device 100. The transmission of the transmission gear 114 and the driving gear 124 enables the rotation speed of the drive rotating shaft 120 of the rotary driving motor 112 to be transmitted to the two output shafts 152, 154 at a reduction ratio of 480:1.

Since the first rotary transmission device 132 and the second rotary transmission device 134 have similar structures and the same working principles, the present disclosure only describes the specific structure of the first rotary transmission device 132, and the structure of the second rotary transmission device 134 is not described in detail herein.

As shown in FIG. 1E, the first rotary transmission device 132 comprises a first connecting and disconnecting device, such as a roller clutch or a sprag clutch. The first connecting and disconnecting device comprises at least one roller or a sprag. The first connecting and disconnecting device has an inner ring 178, an outer ring 172, two cylindrical rollers 174, 175, and two elastic elements 176, 177, wherein the inner ring 178 has two wedge surfaces 182, 183, and the outer ring 172 has an external tooth portion 171 and an inner cylindrical ring surface 173. The outer ring 172 has a rotation axis 162, and the external tooth portion 171 can mesh with the second driving gear tooth portion 144 of the driving gear 124, so that the outer ring 172 can rotate around the rotation axis 162 under driving of the driving gear 124. Those skilled in the art should know that in some other examples, the number of cylindrical rollers and the number of wedge surfaces each are not limited to two, but may be set to one or more than two as required.

The transmission process of the first connecting and disconnecting device is as follows: when the outer ring 172 rotates clockwise, the cylindrical rollers 174, 175 in contact with the outer ring 172 are subjected to friction to move in the same direction as the outer ring 172. In this case, the elastic elements 176, 177 are compressed, so that the elastic elements 176, 177 are deformed. Meanwhile, the cylindrical rollers 174, 175 move toward an area where a space of a wedge area increases, so that a contact force between the inner cylindrical surface 173 of the outer ring, the wedge surfaces 182, 183 of the inner ring, and the cylindrical rollers 174, 175 becomes small, which is not enough to drive the inner ring 178 to rotate. Therefore, when the outer ring 172 rotates clockwise, the inner ring 178 is stationary. When the outer ring 172 rotates counterclockwise, the cylindrical rollers 174, 175 in contact with the outer ring 172 are subjected to friction to move in the same direction as the outer ring 172, and the cylindrical rollers 174, 175 move toward an area where a space of a wedge area decreases. Meanwhile, the elastic elements 176, 177 also push the rollers to move in the direction where the wedge area becomes small, so that a contact force between the inner cylindrical surface 173 of the outer ring, the inner wedge surfaces 182, 183 and the cylindrical rollers 174, 175 becomes large, and the inner ring 178 rotates synchronously and in the same direction as the outer ring 172. Therefore, when the outer ring 172 rotates counterclockwise, the inner ring 178 moves synchronously and in the same direction as the outer ring 172, that is, the inner ring 178 also rotates counterclockwise.

The first rotary transmission device 132 further has a first output shaft 152, which is coaxially fixed to the inner ring 178. When rotating counterclockwise, the inner ring 178 can transmit a rotation torque to the first output shaft 152 to drive a to-be-driven component. It should be noted that the rotation axis 162 of the outer ring 172 and a rotation axis of the first output shaft 152 are coaxially provided, so that the outer ring 172, the inner ring 178 and the first output shaft 152 share the first rotation axis 162.

Similarly, the second rotary transmission device 134 comprises a second connecting and disconnecting device, such as a roller clutch or a sprag clutch. The second connecting and disconnecting device comprises at least one roller or at least one sprag. The second rotary transmission device 134 further has a second output shaft 154 and a second rotation axis 164. An inner ring structure of the second rotary transmission device 134 and an inner ring structure of the first rotary transmission device 132 are provided as a central symmetry structure. Therefore, contrary to the arrangement of the first rotary transmission device 132, the second rotary transmission device 134 can only transmit clockwise rotation of the outer ring thereof to the second output shaft 154, but cannot transmit counterclockwise rotation of the outer ring thereof to the second output shaft 154.

As shown in FIGS. 1B-1C, the first connecting and disconnecting device of the first rotary transmission device 132 and the second connecting and disconnecting device of the second rotary transmission device 134 are arranged at a final output stage of the actuator device 100, so that the first connecting and disconnecting device and the second connecting and disconnecting device can share a transmission mechanism (including, for example, a transmission gear 114 and a driving gear 124), thereby simplifying the structure of the actuator device 100 and saving on manufacturing costs of the actuator device 100.

The first output shaft 152 and the second output shaft 154 are parallel to the driving gear rotating shaft 142 and are spaced apart from the driving gear rotating shaft by a certain distance, that is, the first output shaft 152 and the second output shaft 154 may be symmetrically arranged on two sides or roughly on two sides of the driving gear rotating shaft 142, so that the first output shaft 152 and the second output shaft 154 have more balanced torque outputs, output more stably, and generate no vibration or abnormal sound.

For those of ordinary skill in the art, in different examples, the first output shaft 152 and the second output shaft 154 may be arranged on two sides of the driving gear rotating shaft 142, and centers of the three shafts are collinearly arranged, or lines connecting the centers of the three shafts are roughly triangularly arranged.

For those of ordinary skill in the art, in some other examples, the two output shafts 152, 154 may alternatively be arranged non-parallel to each other. For example, outer ring teeth of the first rotary transmission device 132 or the second rotary transmission device 134 mesh with the second driving gear tooth portion 144 of the driving gear 124 in the form of a bevel gear, so that the output shaft 152 or 154 of the first rotary transmission device 132 or the second rotary transmission device 134 is at a certain angle with the driving gear rotating shaft 142, so that rotation axes of the two output shafts 152, 154 are also arranged at a certain angle with each other.

Therefore, the first connecting and disconnecting device and the second connecting and disconnecting device mentioned above are configured such that when the driving gear 124 rotates clockwise, outer rings of the first connecting and disconnecting device and the second connecting and disconnecting device rotate counterclockwise, so that the outer ring and the inner ring of the first connecting and disconnecting device are in an engaged state while the outer ring and the inner ring of the second connecting and disconnecting device are in a disengaged state. Therefore, a driving force of the rotary driving motor 112 can be transmitted to the first output shaft 152 but cannot be transmitted to the second output shaft 154, and thus the first output shaft 152 can rotate while the second output shaft 154 cannot rotate. On the contrary, when the driving gear 124 rotates counterclockwise, the outer rings of the first connecting and disconnecting device and the second connecting and disconnecting device rotate clockwise, so that the outer ring and the inner ring of the first connecting and disconnecting device are in a disengaged state while the outer ring and the inner ring of the second connecting and disconnecting device are in an engaged state. Therefore, a driving force of the rotary driving motor 112 can be transmitted to the second output shaft 154 but cannot be transmitted to the first output shaft 152, and thus the first output shaft 152 cannot rotate while the second output shaft 154 can rotate.

For those of ordinary skill in the art, in some other examples, based on the same principle of connecting and disconnecting devices, the first connecting and disconnecting device or the second connecting and disconnecting device may alternatively be in a mode of an inner ring input and an outer ring output, or in a mode in which an inner ring input and an outer ring output are mixed with an outer ring input and an inner ring output.

It can be seen that the actuator device according to the present disclosure is a dual-output actuator assembly with a built-in clutch, and can achieve at least the following beneficial technical effects:

First, the actuator device according to the present disclosure has a stable connecting and disconnecting process and a stable output, generates no vibration or abnormal sound, and can implement double outputs by means of a single actuator. The two output shafts are symmetrically arranged with respect to a rotating shaft of the driving gear and are spaced apart by a certain distance, so that outputs of the output shafts are relatively balanced and do not interfere with each other.

Second, the actuator device according to the present disclosure adopts stepless one-way clutches, which can be used with two or more stepless one-way clutches according to working conditions.

Third, the actuator device according to the present disclosure can achieve a function of driving in two or more directions. The driving function can implement independent adjustment in two or more directions.

Fourth, the actuator device according to the present disclosure has a simple structure, a small volume and a light weight according to the solution.

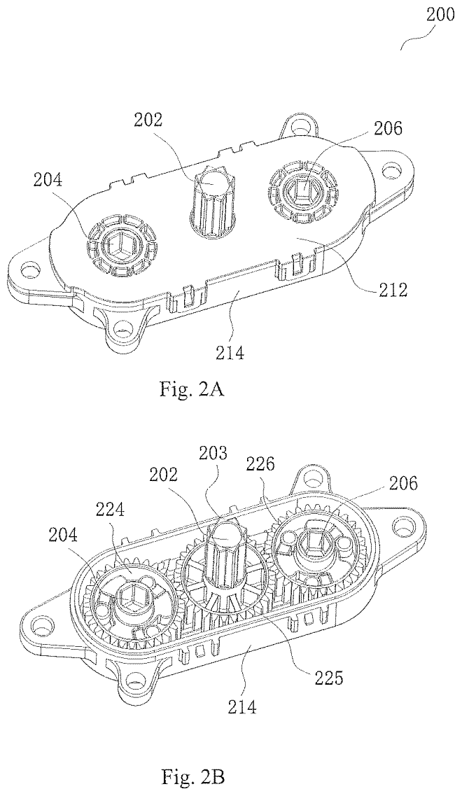

FIGS. 2A-2B show a specific structure of a clutch device 200 according to the present disclosure. FIG. 2A is a perspective view of the clutch device 200 according to the present disclosure, and in FIG. 2B, a clutch upper cover 212 of the clutch device 200 is hidden so as to show more components inside the clutch device 200.

The working principle of the clutch device 200 shown in FIGS. 2A-2B is similar to that of the actuator device 100 shown in FIGS. 1A-1B, except that the clutch device 200 omits a driving component and a decelerating mechanism on the basis of the actuator device 100, and a torque input of the clutch device 200 is provided by connecting an input shaft to an external driving component (such as an actuator or a motor).

As shown in FIGS. 2A-2B, the clutch device 200 comprises a driving gear 225, a first rotary transmission device 224, and a second rotary transmission device 226.

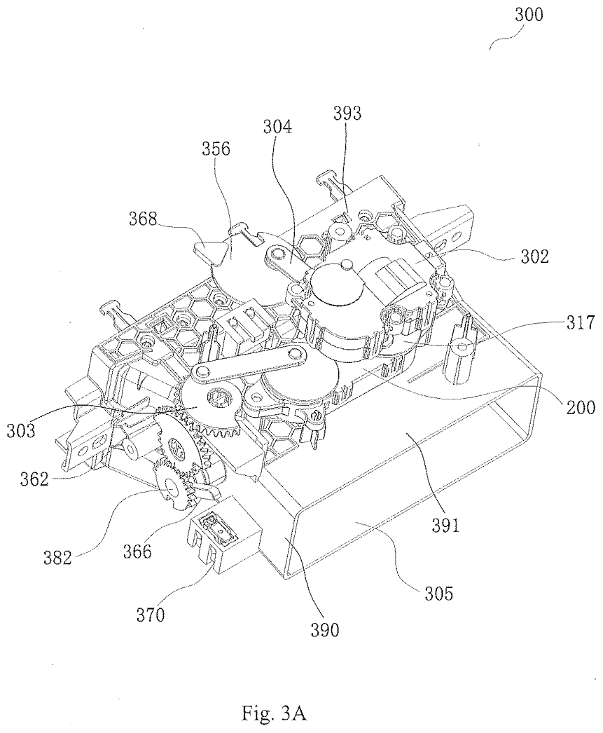

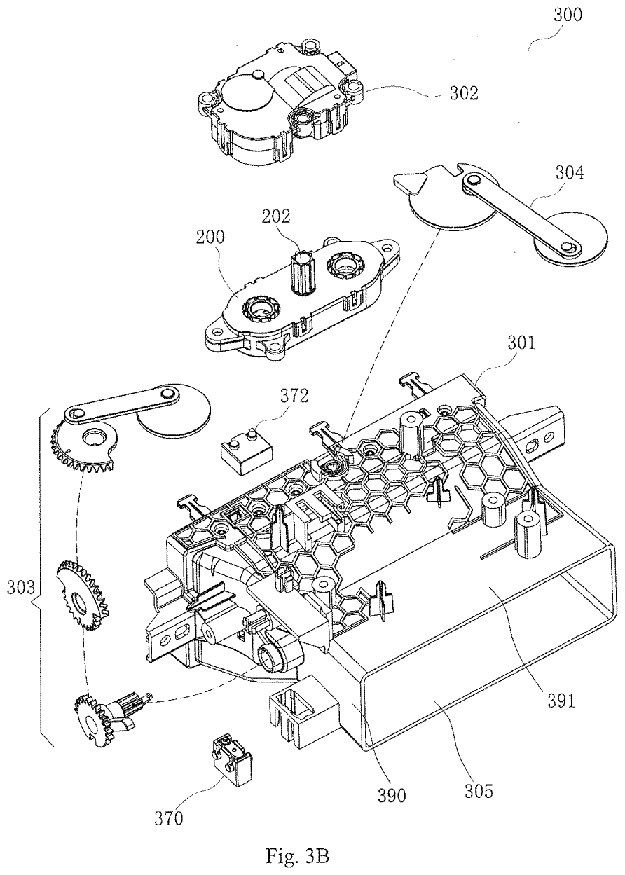

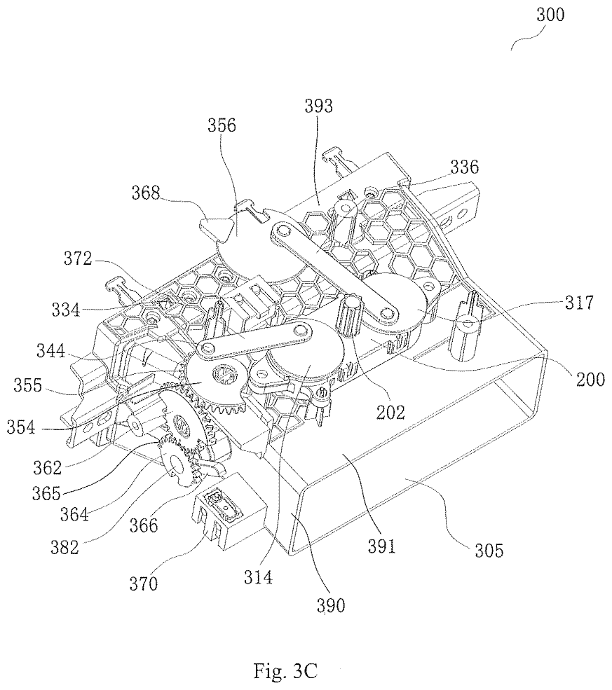

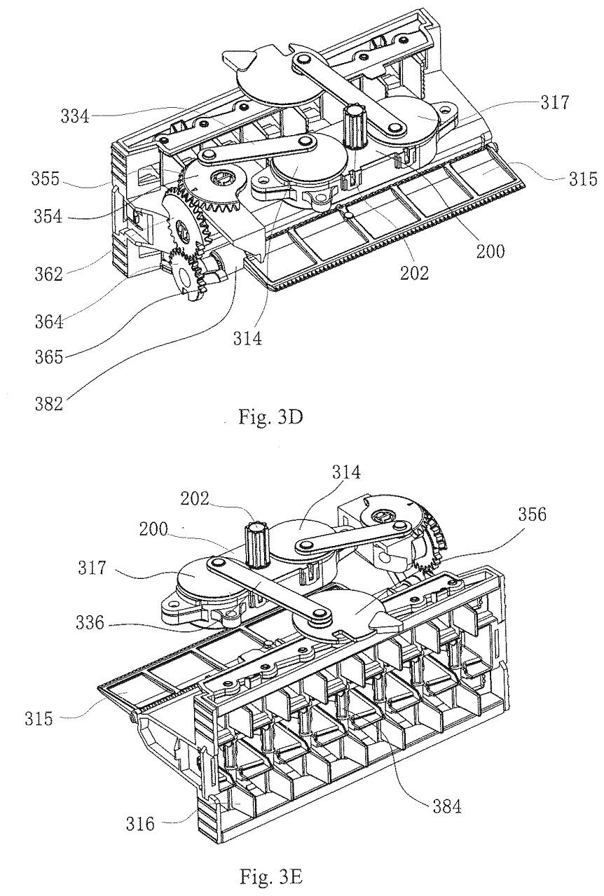

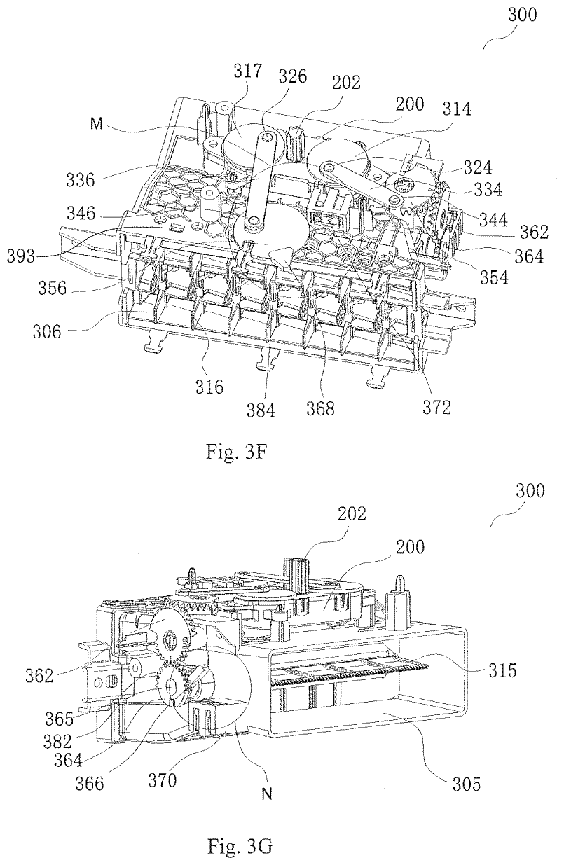

The driving gear 225 comprises a driving gear rotating shaft 202, i.e., an input shaft of the clutch device 200, and the gear rotating shaft 202 is provided with a meshing portion 203 along a circumferential circle for cooperatively connecting to an external driving device 302 (refer to FIG. 3A), so that the driving gear rotating shaft 202 can be driven by the external driving device 302 to rotate clockwise or counterclockwise.

The first rotary transmission device 224 comprises a first connecting and disconnecting device and a first output shaft 204, and the second rotary transmission device 226 comprises a second connecting and disconnecting device and a second output shaft 206. The first connecting and disconnecting device and the second connecting and disconnecting device are roller clutches or sprag clutches. The working principles of the first connecting and disconnecting device and the second connecting and disconnecting device are the same as that of the connecting and disconnecting device in the actuator device 100 above, and are not described in detail herein.

The first connecting and disconnecting device or the second connecting and disconnecting device is configured such that when the driving gear rotating shaft 202 rotates clockwise, the first connecting and disconnecting device is in an engaged state while the second connecting and disconnecting device is in a disengaged state, so that a driving force of the driving gear rotating shaft 202 can be transmitted to the first output shaft 204 but cannot be transmitted to the second output shaft 206, and thus the first output shaft 204 can rotate while the second output shaft 206 cannot rotate; and when the driving gear rotating shaft 202 rotates counterclockwise, the first connecting and disconnecting device is in a disengaged state while the second connecting and disconnecting device is in an engaged state, so that the driving force of the driving gear rotating shaft 202 can be transmitted to the second output shaft 206 but cannot be transmitted to the first output shaft 204, and thus the first output shaft 204 cannot rotate while the second output shaft 206 can rotate.

The first output shaft 204 and the second output shaft 206 may be parallel to the driving gear rotating shaft 202 and may be spaced apart from the driving gear rotating shaft by a certain distance, and may be symmetrically arranged on two sides of the driving gear rotating shaft 202.

For those of ordinary skill in the art, in some other examples, the first output shaft 204 and the second output shaft 206 may alternatively be arranged non-parallel to each other. Referring to the above description about the output shaft in the actuator device 100, rotation axes of the first output shaft 204 and the second output shaft 206 may be provided at an angle with each other.

Therefore, the clutch device 200 according to the present disclosure is a dual-output overrunning clutch system. Similar to the actuator device 100, in an example of the present disclosure, the clutch device 200 may be provided in a mode of an inner ring input and an outer ring output, or a mode of an outer ring input and an inner ring output, or a mode of combining the above two modes.

The clutch device according to the present disclosure can achieve at least the following beneficial technical effects:

First, the clutch device according to the present disclosure can be used in series with any actuator, and can convert a single output of the actuator into double outputs, and the outputs are adjusted independently, so that the outputs of the two output shafts do not interfere with each other.

Second, the clutch device according to the present disclosure has similar advantages to the actuator device described above, including but not limited to a stable connecting and disconnecting process, balanced and stable outputs, and no generation of vibration or abnormal sound.

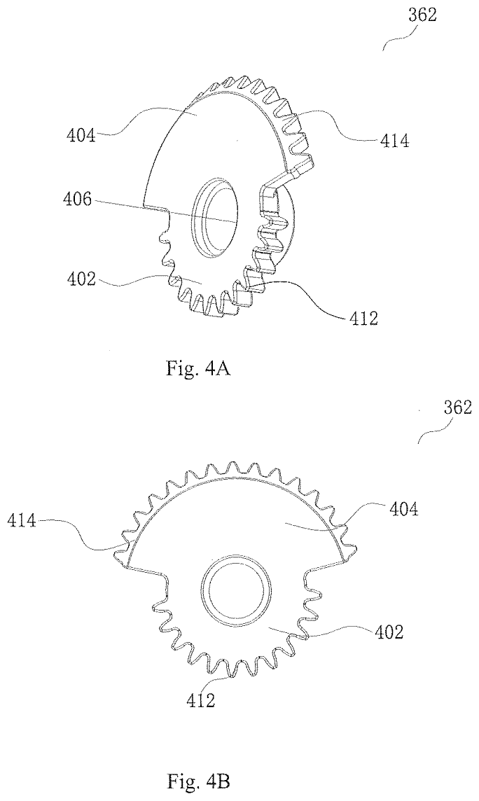

FIGS. 3A-3G show a specific structure of an example of an air outlet device. FIG. 3A is a perspective view of an example of the air outlet device with the clutch device shown in FIGS. 2A-2B. FIG. 3B is an exploded view of the air outlet device shown in FIG. 3A. FIG. 3C is a perspective view of the air outlet device shown in FIG. 3A with a driving device hidden. FIG. 3D is a schematic driving diagram of the air outlet device shown in FIG. 3A from a first perspective. FIG. 3E is a schematic driving diagram of the air outlet device shown in FIG. 3A from a second perspective. FIG. 3F is a perspective view of the air outlet device shown in FIG. 3B from another perspective. FIG. 3G is a perspective view of the air outlet device shown in FIG. 3B from a side perspective. FIGS. 4A-4B show a specific structure of a bevel gear 362 in an air outlet device 300.

As shown in FIGS. 3A-3G, the air outlet device 300 comprises an air outlet housing 301, a clutch device 200 with a single input shaft (driving gear rotating shaft 202), a driving device 302, a first air outlet 305, a second air outlet 306 (see FIG. 3F for details), a first blade group 315 (see FIGS. 3D and 3G for details), and a second blade group 316 (see FIGS. 3E-3F for details). The first blade group 315 is configured to control an air outlet direction of the first air outlet 305 and has a first swing shaft 382, and the second blade group 316 is configured to control an air outlet direction of the second air outlet 306 and has a second swing shaft 384. The air outlet device 300 further comprises a first transmission device 303 and a second transmission device 304. The first transmission device 303 is driven by the first output shaft 204 of the clutch device 200 to drive the first swing shaft 382 to swing, so as to drive the first blade group 315 to swing accordingly. The second transmission device 304 is driven by the second output shaft 206 of the clutch device 200 to drive the second swing shaft 384 to swing, so as to drive the second blade group 316 to swing accordingly. The driving device 302 may be connected in series with the input shaft of the clutch device 200, so as to provide a torque for rotation of the input shaft. Therefore, referring to the description of FIGS. 2A-2B, when the input shaft of the clutch device 200 rotates clockwise, the first output shaft 204 can rotate and the second output shaft 206 cannot rotate, thus driving the first blade group 315 to swing; when the input shaft of the clutch device 200 rotates counterclockwise, the second output shaft 206 can rotate and the first output shaft 204 cannot rotate, thus driving the second blade group 316 to swing.

In the example shown in FIGS. 3C-3D, the first transmission device 303 comprises a first crank-rocker mechanism (referring to a common crank-connecting rod structure in the mechanical field, the specific working principle is not described in detail herein) and a bevel gear 362. Referring to FIG. 3B, the first crank-rocker mechanism comprises a first crank-rocker mechanism input end 314, a first crank-rocker mechanism output end 354, and a first connecting rod 334 for connecting the first crank-rocker mechanism input end 314 to the first crank-rocker mechanism output end 354. A rocker bevel gear portion 355 is arranged in a circumferential direction of the first crank-rocker mechanism output end 354, and is configured to mesh with the bevel gear 362. The bevel gear 362 is in transmission connection with the first swing shaft 382 of the first blade group 315, for example, is connected thereto in a gear meshing mode or in a coaxial arrangement mode. One end of the first swing shaft 382 is coaxially connected to the first blade group 315, and another end of the first swing shaft 382 penetrates through a first air outlet side wall 390 of the first air outlet 305. A first swing shaft tooth portion 364 is provided at an end of the first swing shaft and is configured to mesh with the bevel gear 362.

As shown in FIGS. 4A-4B, the bevel gear 362 has a bevel gear body 402 and a bevel gear portion 404. A bevel gear tooth portion 412 around a lower half of an outer circumference of the bevel gear body 402 is arranged on a circumferential outer side of the bevel gear body 402, and is configured to mesh with external teeth 365 of the first swing shaft tooth portion 364 of the first swing shaft 382. Conical teeth 414 are provided on the bevel gear portion 404, and are configured to mesh with the rocker bevel gear portion 355 of the first crank-rocker mechanism output end 354. A direction in which the conical teeth 414 mesh with the bevel gear portion 355 is at a certain angle with a surface where the bevel gear body 402 is located. Therefore, through meshing transmission between the bevel gear portion 404 of the bevel gear 362 and the rocker bevel gear portion 355 of the first crank-rocker mechanism output end 354, a swing torque on the first crank-rocker mechanism output end 354 may change by a certain angle to be transmitted to the bevel gear 362. In an example of the present disclosure, the changing angle may be 90°.

As shown in FIGS. 3C-3D, during driving of the first blade group 315, the first crank-rocker mechanism input end 314 may be driven to rotate by the rotation of the first output shaft 204. When the first crank-rocker mechanism input end 314 rotates, the first crank-rocker mechanism output end 354 can be driven by the first connecting rod 334 to swing in a direction perpendicular to a first air outlet upper wall 391 of the first air outlet 305. The swing of the first crank-rocker mechanism output end 354 can be converted, by means of meshing transmission with the bevel gear 362, into the swing of the first swing shaft 382 of the first blade group 315 in a direction perpendicular to a first air outlet side wall 390, so that the first blade group 315 swings up and down.

Still as shown in FIGS. 3C and 3E, the second transmission device 304 comprises a second crank-rocker mechanism, which has a second crank-rocker mechanism input end 317, a second crank-rocker mechanism output end 356, and a second connecting rod 336 for connecting the second crank-rocker mechanism input end 317 to the second crank-rocker mechanism output end 356. The second crank-rocker mechanism input end 317 may be driven to rotate by the rotation of the second output shaft 206. One end of the second swing shaft 384 is connected to the second blade group 316, and another end of the second swing shaft 384 penetrates through a second air outlet upper wall 393 of the second air outlet 306, and is cooperatively connected (for example, coaxially connected) to the second crank-rocker mechanism output end 356.

During driving of the second blade group 316, the second crank-rocker mechanism input end 317 may be driven to rotate by the rotation of the second output shaft 206. When the second crank-rocker mechanism input end 317 rotates, the second crank-rocker mechanism output end 356 can be driven by the second connecting rod 336 to swing in a direction perpendicular to the second air outlet upper wall 393, and the swing of the second crank-rocker mechanism output end 356 can drive the second swing shaft 384 of the second blade group 316 to swing in a direction perpendicular to the second air outlet upper wall 393, so that the second blade group 316 swings left and right.

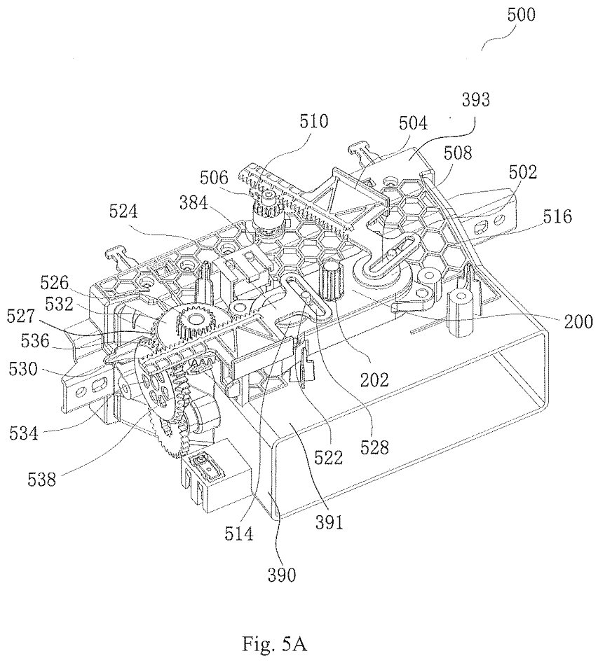

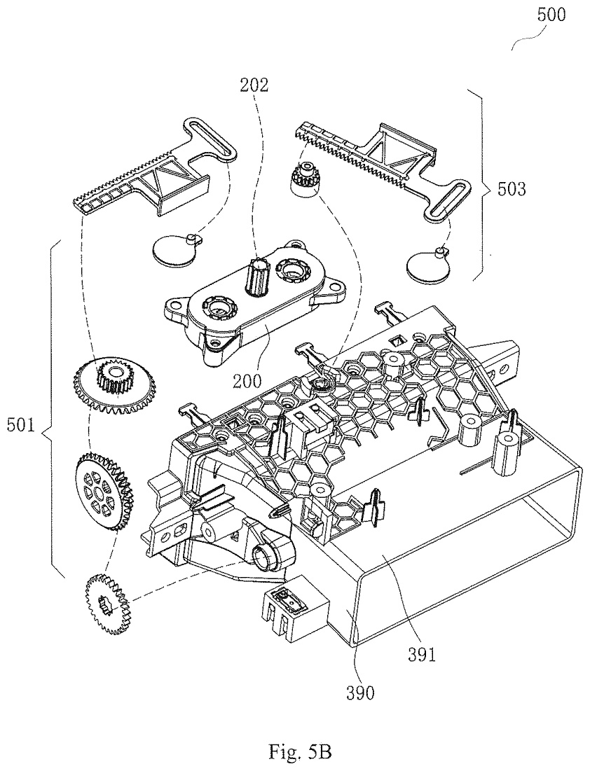

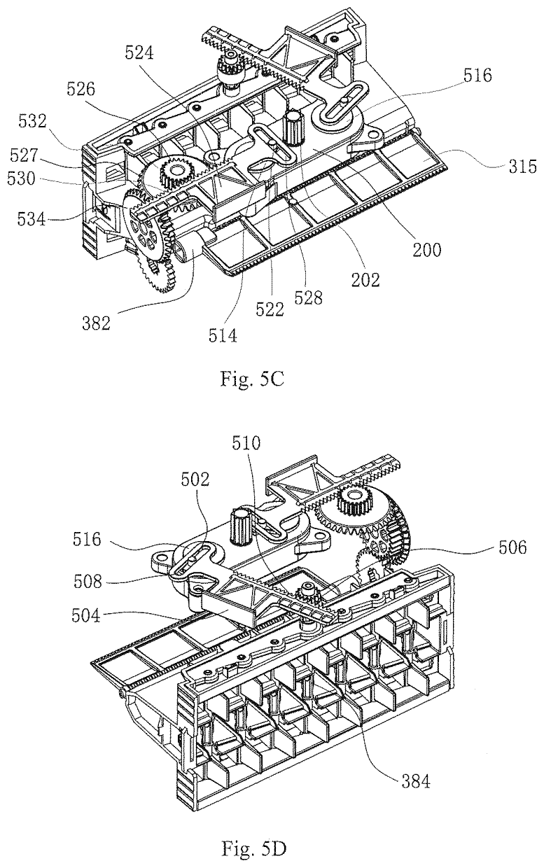

FIGS. 5A-5D show a specific structure of another example of the air outlet device. FIG. 5A is a perspective view of another example of an air outlet device with the clutch device shown in FIGS. 2A-2B. FIG. 5B is an exploded view of the air outlet device shown in FIG. 5A. FIG. 5C is a schematic driving diagram of the air outlet device shown in FIG. 5A from a first perspective. FIG. 5D is a schematic driving diagram of the air outlet device shown in FIG. 5A from a second perspective. The air outlet device 500 shown in FIGS. 5A-5D is different from the air outlet device 300 shown in FIGS. 3A-3G only in a transmission mode of the blade group, that is, the arrangements of the first transmission device and the second transmission device are different, and the same structure is not described in detail again. Specifically, the air outlet device 500 shown in FIG. 5A replaces the crank-rocker mechanism in the air outlet device 300 shown in FIGS. 3A-3G with another transmission mechanism that converts a rotary motion into reciprocating swing.

As shown in FIGS. 5B-5C, a first transmission device 501 of the air outlet device 500 comprises a first eccentric disc 514, a first transmission rack 524, a first transmission gear 532, and a bevel gear 534, wherein the first eccentric disc 514 can be driven to rotate by the rotation of the first output shaft 204. One end of the first transmission rack 524 has a first rack accommodating groove 528, and an extension direction of the first rack accommodating groove 528 is provided at an angle with a length direction of the first transmission rack 524, for example, provided perpendicular thereto. A first eccentric protrusion 522 is provided on the first eccentric disc 514, and the first eccentric protrusion 522 is configured to be accommodated in the first rack accommodating groove 528 and be capable of reciprocating and rotating relative to the first rack accommodating groove 528. Another end of the first transmission rack 524 is provided with a first rack portion 530, which can be in meshing transmission with the first transmission gear 532. The first transmission gear 532 has an external tooth portion 526 and a transmission gear bevel gear portion 527 that are arranged coaxially. The external tooth portion 526 can mesh with the first rack portion 530 of the first transmission rack 524, and the transmission gear bevel gear portion 527 is in meshing transmission with the bevel gear 534.

When the first eccentric disc 514 rotates, the first rack accommodating groove 528 provided at one end of the first transmission rack 524 can reciprocatively translate through an eccentric fit with the first eccentric protrusion 522 on the first eccentric disc 514, and the first transmission gear 532 swings in a direction perpendicular to the first air outlet upper wall 391 through meshing transmission between the first rack portion 530 of the first transmission rack 524 and the external tooth portion 526 of the first transmission gear 532. The swing of the first transmission gear 532 can be converted into the swing of the bevel gear 534 in a direction perpendicular to the first air outlet side wall 390 through meshing transmission between the transmission gear bevel gear portion 527 and the bevel gear 534, and then is transmitted and converted into the swing of the first swing shaft 382 of the first blade group 315 in a direction perpendicular to the first air outlet upper wall 390, so that the first blade group 315 swings up and down.

As shown in FIGS. 5B and 5D, a second transmission device 503 of the air outlet device 500 comprises a second eccentric disc 516, a second transmission rack 504, and a second transmission gear 506, wherein the second transmission gear 506 is arranged coaxially with the second swing shaft 384 of the second blade group 316, and the second eccentric disc 516 can be driven to rotate by the rotation of the second output shaft 206.

One end of the second transmission rack 504 has a second rack accommodating groove 508, and an extension direction of the second rack accommodating groove 508 is provided at an angle with a length direction of the second transmission rack 504, for example, provided perpendicular thereto. A second eccentric protrusion 502 is provided on the first eccentric disc 516, and the second eccentric protrusion 502 is configured to be accommodated in the second rack accommodating groove 508 and be capable of reciprocating and rotating relative to the second rack accommodating groove 508. Another end of the second transmission rack 504 is provided with a second rack portion 510, which can be in meshing transmission with the second transmission gear 506.

When the second eccentric disc 516 rotates, the second rack accommodating groove 508 provided at one end of the second transmission rack 504 can reciprocatively translate through an eccentric fit with the second eccentric protrusion 502 on the second eccentric disc 516, and the second transmission gear 506 swings in a direction perpendicular to the second air outlet upper wall 393 through meshing transmission between the second rack portion 510 on the other side of the second transmission rack 504 and the second transmission gear 506. The swing of the second transmission gear 506 enables the second swing shaft 384 of the second blade group 316 to swing in a direction perpendicular to the second air outlet upper wall 393, thus making the second blade group 316 swing left and right.

For those of at least ordinary skill in the art, in some other examples, the first transmission device and the second transmission device (such as crank rockers or eccentric discs, swinging racks, and transmission gear mechanisms) in the air outlet device 300 and the air outlet device 500 can alternatively be mutually replaced and arranged in a cross way.

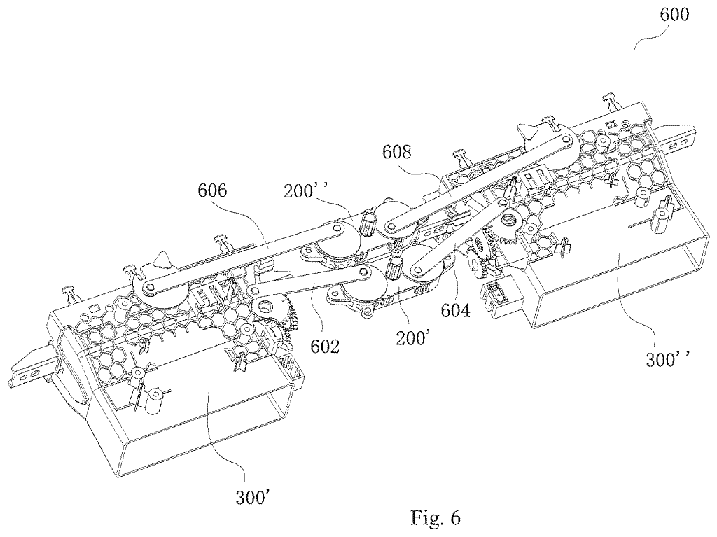

FIG. 6 is a perspective view of an air outlet device system 600 with the clutch device 200 shown in FIGS. 2A-2B.

As shown in FIG. 6, the air outlet device system 600 comprises a first clutch device 200′, a second clutch device 200″, a first air outlet device 300′, and a second air outlet device 300″, wherein each of the first clutch device 200′ and the second clutch device 200″ has a first output shaft and a second output shaft.

The first output shaft and the second output shaft of the first clutch device 200′ can respectively drive first blade groups of the first air outlet device 300′ and the second air outlet device 300″ by a first transmission device 602 and a second transmission device 604, and the first output shaft and the second output shaft of the second clutch device 200″ can respectively drive second blade groups of the second air outlet device 300′ and the second air outlet device 300″ by a third transmission device 606 and a fourth transmission device 608.

For those of at least ordinary skill in the art, in some other examples, more than two clutch devices and more than two air outlet devices may alternatively be arranged in the air outlet device system 600 to implement cross drive or control of a plurality of clutch devices over a plurality of air outlet devices.

For those of at least ordinary skill in the art, in some other examples, the air outlet device 300, the air outlet device 500 and the air outlet device system 600 according to the present disclosure may alternatively be driven by the actuator device 100 shown in FIGS. 1A-1C.

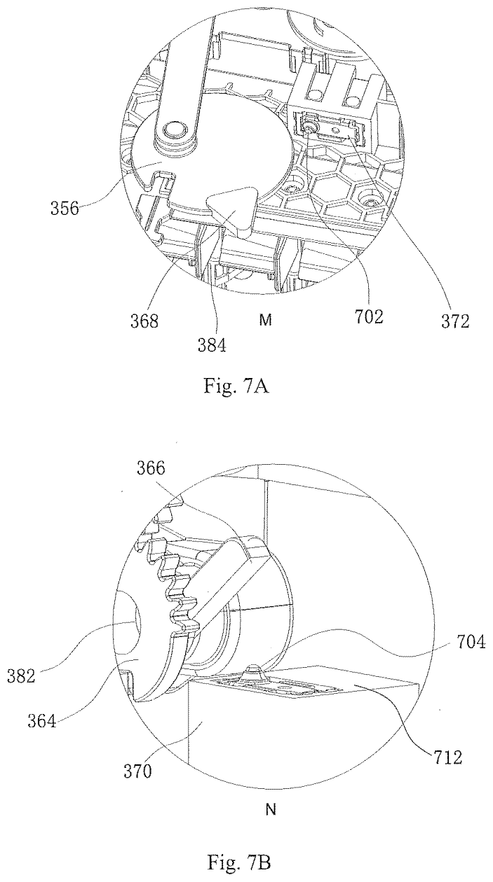

FIGS. 7A and 7B are enlarged views M and N of blade control systems in FIGS. 3F and 3G.

Working principles of the blade control systems shown in FIGS. 7A and 7B are basically the same, and the working principle is described with the blade control system shown in FIG. 7B as an example.

As shown in FIGS. 3G and 7B, the air outlet device 300 has a blade control system, and the blade control system comprises a first blade group 315, a first position detecting device 370, a position detecting device actuating portion 366, and a control device (not shown in the figures), wherein the first position detecting device 370 has a first trigger switch 704, which may be one of a microswitch, a Hall sensor, an optical signal position sensor, or an acoustic signal position sensor. One end of the position detecting device actuating portion 366 is fixedly connected to the first swing shaft 382, and another end thereof extends outward in a radial direction to actuate the first trigger switch 704. The first trigger switch 704 has a protruding position and a recessed position. When the first trigger switch 704 is in the protruding position, the first trigger switch 704 protrudes from an upper surface 712 of the first position detecting device 370 and is arranged opposite the position detecting device actuating portion 366.

The first blade group 315 can swing within a specific angle range, and the angle range comprises a first swing boundary position (corresponding to a position to which the position detecting device actuating portion 366 swings to be in contact with the first trigger switch 704 in FIG. 7B) and a second swing boundary position (corresponding to a position shown in FIG. 7B, which is reached by rotating counterclockwise by a certain angle). This specific angle range is defined by the first swing boundary position and the second swing boundary position. Since the position detecting device actuating portion 366 and the first swing shaft 382 are coaxially and fixedly arranged, the swing of the first blade group 315 between the first swing boundary position and the second swing boundary position can be reflected as the swing of the position detecting device actuating portion 366. When the first blade group 315 swings to the first swing boundary position, the position detecting device actuating portion 366 is in contact with the first trigger switch 704 and presses the first trigger switch 704 from the protruding position to the recessed position, so that the first trigger switch 704 causes the first position detecting device 370 to generate a first boundary position signal to instruct the first blade group 315 to swing to the first swing boundary position.

The control device is configured to be capable of receiving an air outlet blade position signal set by a user, and according to the air outlet blade position signal, the control device can obtain an angle by which the blade group needs to swing from a swing boundary position.

If the first blade group 315 is not in the first swing boundary position when the air outlet blade position signal is received, the control device controls the first blade group 315 to swing until the first blade group 315 swings to the first swing boundary position. If the first blade group 315 is just in the first swing boundary position or has swung to the first swing boundary position when the air outlet blade position signal is received, the first trigger switch 704 is triggered, and the first position detecting device 370 immediately generates a first boundary position signal. In this case, the control device can control the first blade group 315 to swing by a corresponding angle according to a swing angle calculated by means of a user-set air outlet blade position signal, and the first boundary position signal from the first position detecting device 370, until the first blade group 315 swings to a user-set blade position, and then the swing of the first blade group 315 is stopped. In this way, no matter where the first blade group 315 is located, as long as the user-set air outlet blade position signal is received, the first blade group 315 can be accurately controlled to swing to the user-set blade position.

Working in the same manner as the above, the blade control system shown in FIGS. 3F and 7A comprises a second blade group 316, a second position detecting device 372, a position detecting device actuating portion 368, and a control device (not shown in the figures), wherein the second position detecting device 372 has a second trigger switch 702, which may be one of a microswitch, a Hall sensor, an optical signal position sensor, or an acoustic signal position sensor. The position detecting device actuating portion 368 can trigger the second trigger switch 702 of the second position detecting device 372, so that the second position detecting device 372 generates a boundary position signal, and then the second blade group 316 is instructed to swing to a boundary position.

If the second blade group 316 is not in the second swing boundary position when the air outlet blade position signal is received, the control device controls the second blade group 316 to swing until the second blade group 316 swings to the second swing boundary position. If the second blade group 316 is just in the second swing boundary position or has swung to the second swing boundary position when the air outlet blade position signal is received, the second trigger switch 702 is triggered, and the second position detecting device 372 immediately generates a second boundary position signal. In this case, the control device can control the second blade group 316 to swing by a corresponding angle according to a swing angle calculated by means of a user-set air outlet blade position signal, and the second boundary position signal from the second position detecting device 372, until the second blade group 316 swings to the user-set blade position, and then the swing of the second blade group 316 is stopped.

Compared with the prior art, the actuator device, the clutch device, and the air outlet device according to the present disclosure have the following beneficial technical effects:

Output shafts of the actuator device or the clutch device in the present disclosure are spaced apart by a certain distance and extend upward, so that blade transmission devices (such as a crank-rocker mechanism, an eccentric disc, a swinging rack, and a transmission gear, etc.) connected to the output shafts can be concentrated on the same plane (such as an upper surface of an air outlet chamber) or on two planes spaced apart by a small distance, that is, the swing of a group of left and right blades and the swing of a group of upper and lower blades are controlled by the same input source, which is helpful for rational utilization and simple control of a space of an air outlet control device. In addition, with the arrangement of a blade position detecting device, blades can be accurately controlled to swing to a set position regardless of any position of the blades.

Although the present disclosure is described in conjunction with the examples of examples outlined above, various alternatives, modifications, variations, improvements, and/or substantial equivalents that are known or current or to be anticipated before long may be obvious to those of at least ordinary skill in the art. In addition, the technical effects and/or technical problems described in the present disclosure are illustrative rather than restrictive. Therefore, the disclosed description in the present disclosure may be used to solve other technical problems and have other technical effects and/or may solve other technical problems. Accordingly, the examples of the examples of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

What is claimed is:

1. An actuator device, comprising:
a driving component comprising a drive rotating shaft, and the driving component being configured to be capable of driving the drive rotating shaft to rotate in a first rotation direction or a second rotation direction;
a gear comprising a gear rotating shaft, and the gear being configured to be driven by the drive rotating shaft to rotate in the first rotation direction or the second rotation direction;
a first rotary transmission device comprising a first connecting and disconnecting device, and the first rotary transmission device having a first output shaft; and
a second rotary transmission device comprising a second connecting and disconnecting device, and the second rotary transmission device having a second output shaft,
wherein the first connecting and disconnecting device and the second connecting and disconnecting device are configured such that:
when the gear rotates in the first rotation direction, the first rotary transmission device is driven to allow the first connecting and disconnecting device to be driven into an engaged state such that the first output shaft rotates, and the second rotary transmission device is driven to allow the second connecting and disconnecting device to be driven into a disengaged state such that the second output shaft does not rotate;
when the gear rotates in the second rotation direction, the second rotary transmission device is driven to allow the second connecting and disconnecting device to be driven into an engaged state such that the second output shaft rotates, and the first rotary transmission device is driven to allow the first connecting and disconnecting device to be driven into a disengaged state such that the first output shaft does not rotate.

2. The actuator device of claim 1, wherein
the first output shaft and the second output shaft are spaced apart from the gear rotating shaft by a certain distance.

3. The actuator device of claim 1, wherein
the first output shaft and the second output shaft are arranged on two sides of the gear rotating shaft.

4. The actuator device of claim 1, wherein
the first output shaft and the second output shaft are symmetrically arranged with respect to the gear rotating shaft.

5. The actuator device of claim 1, wherein
the first connecting and disconnecting device and the second connecting and disconnecting device are roller clutches or sprag clutches, and wherein either the first connecting and disconnecting device or the second connecting and disconnecting device comprises at least one roller or at least one sprag.

6. The actuator device of claim 1, further comprising:
a transmission mechanism being configured to be cooperatively connected to the driving component and the gear to transfer a torque of the drive rotating shaft of the driving component to the gear.

7. The actuator device of claim 6, wherein the transmission mechanism is a decelerating mechanism for allowing a rotation speed of the gear to be lower than that of the drive rotating shaft.

8. The actuator device of claim 1, wherein rotation of the drive rotating shaft of the driving component in the first rotation direction or the second rotation direction is controlled by means of a controller.

9. The actuator device of claim 1, wherein the first rotation direction is opposite to the second rotation direction.

10. The actuator device of claim 1, wherein the first connecting and disconnecting device and the second connecting and disconnecting device are configured at a final output stage of the actuator device.

11. A clutch device, comprising:
a gear comprising a gear rotating shaft, and the gear rotating shaft being configured to be driven by a driving device to rotate in a first rotation direction or a second rotation direction;
a first rotary transmission device comprising a first connecting and disconnecting device, and the first rotary transmission device having a first output shaft; and
a second rotary transmission device comprising a second connecting and disconnecting device, and the second rotary transmission device having a second output shaft,
wherein the first connecting and disconnecting device and the second connecting and disconnecting device are configured such that:
when the gear rotating shaft rotates in the first rotation direction, the first rotary transmission device is driven to allow the first connecting and disconnecting device to be driven into an engaged state such that the first output shaft rotates, and the second rotary transmission device is driven to allow the second connecting and disconnecting device to be driven into a disengaged state such that the second output shaft does not rotate;
when the gear rotating shaft rotates in the second rotation direction, the second rotary transmission device is driven to allow the second connecting and disconnecting device to be driven into an engaged state such that the second output shaft rotates, and the first rotary transmission device is driven to allow the first connecting and disconnecting device to be driven into a disengaged state such that the first output shaft does not rotate.

12. The clutch device of claim 11, wherein the first output shaft and the second output shaft are spaced apart from the gear rotating shaft by a certain distance.

13. The clutch device of claim 11, wherein the first output shaft and the second output shaft are arranged on two sides of the gear rotating shaft.

14. The clutch device of claim 11, wherein the first output shaft and the second output shaft are symmetrically arranged with respect to the gear rotating shaft.

15. The clutch device of claim 11, wherein the first connecting and disconnecting device and the second connecting and disconnecting device are roller clutches or sprag clutches, and wherein either the first connecting and disconnecting device or the second connecting and disconnecting device comprises at least one roller or at least one sprag.

16. The clutch device of claim 11, wherein the first rotation direction is opposite to the second rotation direction.

17. An air outlet device, comprising an actuator device of claim 1.

18. The air outlet device of claim 17, further comprising:
a first blade group and a second blade group,
wherein the rotation of the driving device or the gear rotating shaft in the first rotation direction is capable of driving the first blade group, and the rotation of the driving device or the gear rotating shaft in the second rotation direction is configured to drive the second blade group.

19. An air outlet device, comprising a clutch device of claim 13.

20. The air outlet device of claim 19, further comprising:
a first blade group and a second blade group,
wherein rotation of the driving device or the gear rotating shaft in the first rotation direction is capable of driving the first blade group, and the rotation of the driving device or the gear rotating shaft in the second rotation direction is configured to drive the second blade group.
